(19) United States
(12) Patent Application Publication
(10) Pub. No.: US 2014/0057513 A1
(43) Pub. Date: Feb. 27, 2014

(54) THREAD, SHEET MATERIAL, INSECT SCREEN, AND METHOD FOR PRODUCING A SHEET MATERIAL

(71) Applicants: Carsten Bräuer, Bocholt (DE); Rolf Brüggemann, Gescher (DE); Norbert Gernemann, Rhede (DE); Rolf Büdding, Bocholt (DE)

(72) Inventors: Carsten Bräuer, Bocholt (DE); Rolf Brüggemann, Gescher (DE); Norbert Gernemann, Rhede (DE); Rolf Büdding, Bocholt (DE)

(73) Assignees: SAATI Deutschland GmbH, Raesfeld (DE); TRITTEC AG, Wittenförden (DE)

(21) Appl. No.: 13/809,390

(22) PCT Filed: Jul. 9, 2010
(86) PCT No.: PCT/EP10/04212

§ 371 Date: Oct. 28, 2013

(51) Int. Cl. E06B 9/52; D03D 9/00; D02G 3/02; D02G 3/36

(52) U.S. Cl. CPC E06B 9/52; D02G 3/36; D03D 9/00; D02G 3/02
USPC 442/3; 427/430.1; 156/73.5; 156/73.2; 428/395; 442/1

(57) ABSTRACT

Embodiments of the invention provide a thread (4, 5) for producing a sheet material (2), having a mesh structure, for an insect screen (1), the thread being composed essentially of a carrier material that is triboelectrically chargeable by an air stream, it is proposed that the thread is provided, in particular completely, with a coating (11) containing a hydrophobic coating material.

### CROSS REFERENCE TO RELATED APPLICATIONS

This application is the National Phase Application under 35 USC §371 of International Application No. PCT/EP2010/004212, filed Jul. 9, 2010.

### BACKGROUND

A. Technical Field

The present invention relates to a thread for producing a sheet material, having a mesh structure, for an insect screen, the thread being composed essentially of a carrier material that is triboelectrically chargeable by an air stream.

Moreover, the invention relates to a sheet material, in particular a woven fabric, warp-knitted fabric, and/or weft-knitted fabric, for an insect screen having a number of threads arranged in a mesh structure.

The invention further relates to an insect screen.

Lastly, the invention relates to a method for producing a sheet material, in particular a woven fabric, according to one of claims 5 through 8.

B. Background of the Invention

Within the meaning of the present invention, the term “woven fabric” is understood to mean hand- or machine-produced woven products composed of at least two thread systems that are crossed in particular at right angles or substantially at right angles. The terms “warp-knitted fabric” and “weft-knitted fabric” are understood to mean knitted goods in which one thread loop is looped into another. In the weft-knitted fabric, however, one mesh is produced next to the other (the thread runs horizontally along a mesh row), while in the warp-knitted fabric, the thread forms superposed meshes (the thread runs vertically, and with the adjacent thread forms a mesh wale). Threads, sheet material, and a method of the type stated at the outset are known in particular from DE 100 53 229 A1. The woven fabric, produced from the generic threads, in an insect screen is used on the one hand as protection against the entry of insects when the insect screen is appropriately mounted behind an openable window. It is then possible, as is generally known, to open the window, for example for ventilation, without insects being able to enter the room.

As a rule, for producing the insect screen a woven fabric is fixed in a suitable frame which is mounted behind the window frame. There is a general requirement here that the woven fabric as a whole has the highest possible permeability to light and air, and is invisible to the greatest extent possible.

On the other hand, the known woven fabric may be used to achieve a filtering effect with respect to pollen. To achieve this effect, in DE 100 53 229 A1 it is proposed, on the one hand, to dimension the free surface area of a mesh of the mesh structure of the known woven fabric in the range of 300 to 90,000 μm. On the other hand, for achieving a filtering effect with respect to pollen it is proposed in DE 100 53 229 A1 to electrostatically charge the woven fabric. For the electrostatic charging, according to this prior art it is proposed to rub a material against the woven fabric, to pass air through the woven fabric using a hair dryer, blower, ventilator, or fan, or to remove from the woven fabric a polymer film which is applied over the entire surface of the woven fabric. As a result of the interaction of the selected dimensioning of the mesh width and the charging of the woven fabric, the filtering effect with respect to pollen may be achieved in the prior art by making use of the fact that the pollen is generally electrically charged.

A similar procedure is also previously known from DE 44 14 728 A1. This document proposes to form an electrical field between the allergen and the woven fabric by charging net-like woven fabrics made of synthetic high-polymer fibers, the electrical field being used for the filtration.

A disadvantage of the known woven fabrics and the corresponding threads, however, is that their use is extremely inconvenient, since the application of the charge must be frequently repeated by the user, depending on the environmental conditions. In particular when the humidity increases or when it is raining, the known woven fabric disadvantageously discharges. For this case, DE 100 53 229 A1 provides that the woven fabric must be dried and then recharged by rubbing with a suitable polymer material. As an alternative, for recharging the woven fabric it is proposed to dry and recharge in one work step solely by intensively passing particle-laden air through the woven fabric, using a household hair dryer. However, the proposed measures are disadvantageously very impractical for the user, and require active involvement.

Another disadvantage of the woven fabric known from DE 100 53 229 A1 is that its mesh width is almost an order of magnitude smaller than woven fabrics that are optimized only for insect protection, which has an adverse effect on the air and light permeability as well as the substantial invisibility of the woven fabric that is sought.

### SUMMARY OF THE INVENTION

Against this background, the object of the present invention is to provide a thread, a sheet material, and an insect screen of the type mentioned at the outset which ensure effective protection against insects and also against pollen under various environmental conditions.

A further object of the present invention is to propose a method for producing this type of woven fabric.

For a thread for producing a sheet material having a mesh structure, the object is achieved according to the invention in that the thread is composed essentially of the carrier material which is triboelectrically chargeable by an air stream and which is provided, in particular completely, with a coating containing a hydrophobic coating material. It has surprisingly been found that according to the invention, threads provided with a hydrophobic coating statically charge on their own in air, without the need for active charging as provided in the prior art. A thread according to the invention is therefore ideally suited for producing a sheet material, having a mesh structure, for an insect screen. This is because the self-chargeability and the likewise empirically observed long-term prevention of discharge of the electrostatic charge when the carrier material is suitably selected advantageously allow the mesh width of a woven fabric for an insect screen, produced from the thread according to the invention, to be selected in a range that is customary for strictly insect screens, and yet achieve not only protection against insects, but also a filtering effect with respect to the pollen, which is much smaller. The thread according to the invention is thus also advantageously suited for producing a woven fabric having the best possible light and air permeability, with low visibility.

The stated advantageous properties of the thread according to the invention are achieved in particular when the carrier material includes a preferably monofilament polymer material, in particular polyester. Within the scope of the invention, however, any material that occupies a position in a triboelectrical series which is different than air or common air-containing particles is suitable in principle. In this regard, finding other suitable carrier materials poses no problems to those skilled in the art within the scope of their capabilities.

In one preferred embodiment of the thread according to the invention, the coating material includes a fluoropolymer, in particular polytetrafluoroethylene (PTFE). It has been shown that this material is particularly suitable for the carrier material, on the one hand with regard to ease of application to the carrier material, and on the other hand, the hydrophobic effect.

When in one embodiment of the invention the thread according to the invention has a thickness selected from the interval from 0.1 mm to 0.2 mm, an optimum results, on the one hand, with respect to the low visibility of the woven fabric which is basically sought, and on the other hand, the required strength of the woven fabric. In this regard, a thread thickness of 0.15 mm has proven to be particularly suitable.

The object directed to a sheet material for an insect screen, having a number of threads arranged in a mesh structure, is achieved according to the invention in that at least some of the threads are designed according to one of claims 1 through 4. In this way, according to the invention the woven fabric may achieve a filtering effect with respect to pollen, even for a mesh width that greatly exceeds the typical size of pollen, without any active measures being required from the user in order to electrically charge the woven fabric.

In particular, in one embodiment of the sheet material according to the invention a width of the mesh structure is at least 0.7 mm. The mesh width is advantageously selected to be small enough that it is just under the opening size which keeps troublesome insects from passing through the sheet material, in particular woven fabric, so that under this boundary condition the greatest possible air and light permeability with low visibility of the sheet material is ensured.

In another advantageous embodiment of the sheet material according to the invention, it is provided that the mesh structure includes warp threads and weft threads which are bonded to one another at crossing points by an adhesive, the adhesive including in particular polyester resin, preferably in aqueous solution. As a result of this type of bonding of the sheet material, the sheet material is particularly stable in the cured state of the polyester resin. In this regard, polyester resins have the advantage that they are hard and typically clear in the cured state. In addition, the polyester resins are advantageously resistant to weak acids/bases as well as gasoline and oil.

In one embodiment of the invention, the sheet material may also be provided with a stiffening agent, in particular including a polyurethane dispersion, for stiffening the sheet material.

When in another advantageous embodiment of the invention the warp threads and/or the weft threads are roughened, in particular using a finishing agent, this advantageously produces a matte finish of the threads, resulting in an improved optical property regarding the invisibility of the insect screen. In addition, the roughening advantageously ensures improved bonding of the adhesive to the crossing points. Furthermore, under certain circumstances the hydrophobic coating material or the coating containing this coating material adheres better to the carrier material when the carrier material is roughened beforehand.

In another preferred embodiment of the sheet material according to the invention, the mesh structure includes warp threads and weft threads which are welded to one another at crossing points. The welding of the warp threads to the weft threads at crossing points on the one hand results in particularly good bonding of the sheet material, and on the other hand ensures that a cross-sectional surface of the meshes is not reduced due to the bonding, for example as the result of excess adhesive. In addition, the welded crossing points have the advantage that the adhesion of the hydrophobic coating material is not impaired by possible adhesive at the crossing points, so that unwanted discharge of the electrostatic charge in the area of the crossing points may advantageously be effectively avoided.

The object is also achieved by an insect screen which is characterized by a sheet material, in particular a woven fabric, according to one of claims 5 through 8.

The object directed to a method for producing a sheet material is achieved by a method in which a coating containing a hydrophobic coating material is applied to a thread that is composed essentially of a carrier material which is triboelectrically chargeable by an air stream, preferably in that the sheet material is drawn through a container filled with a medium containing the coating material. The sheet material preferably passes at constant speed through a trough provided with the medium in order to wet the woven fabric with the medium. In particular a Foulard trough, which as used for comparable purposes in the textile industry is familiar to experts in the field, is suitable as a container.

In one preferred embodiment of the invention, the sought dispersion of the hydrophobic coating material over the carrier material of the thread of the sheet material for an insect screen is achieved in a particularly effective manner when the sheet material is drawn through a medium containing the coating material, preferably in dispersion, in particular diluted with water.

The method according to the invention is even further improved when the warp threads arranged in a mesh structure are welded to weft threads at crossing points, in particular by means of ultrasound. As described above, very stable bonding of the sheet material may thus be achieved without reducing the effective clear mesh width at the crossing points, and without impairing adhesion of the hydrophobic coating to the carrier material of the threads in the area of the crossing points, for example due to interaction with an adhesive.

It is known that in ultrasonic welding, a high-frequency vibration due to friction between the threads to be welded generates heat, as is known to those skilled in the art. In conjunction with the method according to the invention, ultrasonic welding has the advantage that short welding times may be realized.

In another advantageous embodiment of the method according to the invention, it is provided that the warp threads arranged in a mesh structure are adhesively bonded to weft threads at crossing points by means of an adhesive, the adhesive in particular being contained in the medium.

### BRIEF DESCRIPTION OF THE DRAWINGS

The invention is described by way of example in a preferred embodiment, with reference to the drawing, wherein further advantageous details may be inferred from the figures of the drawing.

Functionally equivalent parts are provided with the same reference numerals.

The figures of the drawing show the following:

FIG. 1 shows an insect screen having a woven fabric according to the invention, composed of a number of threads according to the invention; and

FIG. 2(a) shows a schematic sectional view along the line II-II in FIG. 1 of the woven fabric according to the invention, in a design having welded crossing points; (b) shows an enlarged detail of section B in part (a) of the figure.

### DETAILED DESCRIPTION OF THE PREFERRED EMBODIMENTS

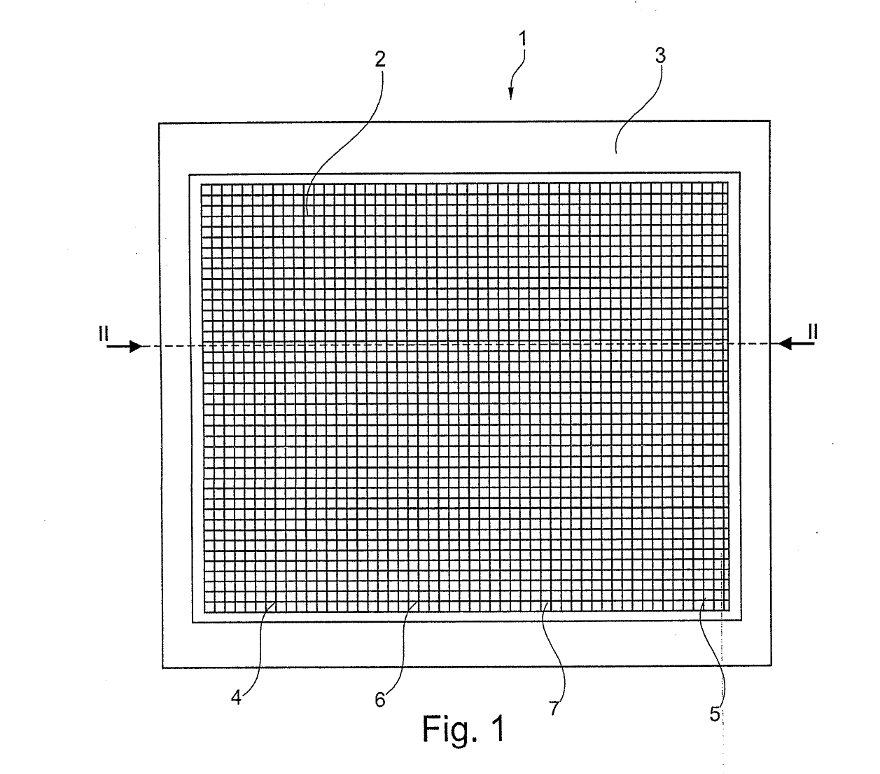

FIG. 1 shows a schematic illustration of an insect screen 1. The insect screen 1 is composed essentially of an insect screen woven fabric 2 according to the invention, which is bordered by a frame 3 in a manner that is generally known and not described in greater detail. The insect screen woven fabric 2 is composed of warp threads 4, which in FIG. 1 run vertically, and weft threads 5 which run at right angles to the warp threads. The terms “warp threads” and “weft threads” refer to a known production process in weaving. Within the scope of the present invention, however, it makes no difference which threads are warp threads or weft threads, or which were warp threads or weft threads during production.

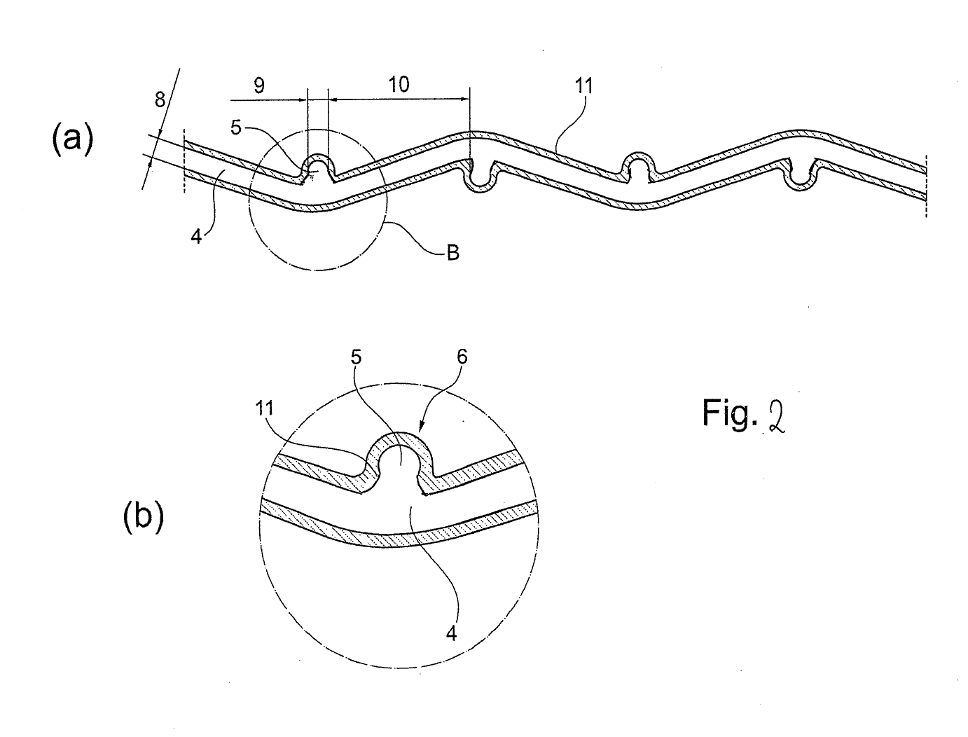

The warp threads 4 together with the weft threads 5 form crossing points 6 at each of the intersection points. The insect screen woven fabric 2 according to the invention in FIG. 1 thus has a woven structure with meshes 7. The warp threads 4 and weft threads 5 are made of a carrier material composed of monofilament threads of polyethylene terephthalate (PET). The design of the threads 4, 5 is described in greater detail below with reference to FIG. 2.

FIG. 2 schematically shows a portion of a section along the line II-II in FIG. 1 through the insect screen woven fabric 2 according to the invention. The thread thickness 8 of the warp threads 4 is 0.15 mm. Likewise, the thread thickness 9 of the weft threads 5 is 0.15 mm. A width 10 of the meshes 7 is 1.1 mm. The meshes have a square cross-sectional area. The free cross section per mesh is accordingly 1.21 mm2. Within the scope of the invention, rectangular or any other desired shapes of the cross-sectional area are conceivable.

It is also apparent from FIG. 2 that the insect screen woven fabric 2 is provided with a hydrophobic coating 11. The hydrophobic coating 11 is applied over the entire surface of the warp threads 4 and of the weft threads 5. The hydrophobic coating 11 is composed of a dispersion containing fluoropolymer. PTFE is a particularly suitable material for the hydrophobic coating 11.

As schematically indicated in particular in FIG. 2b, the warp threads 4 are welded to the weft threads 5 in the area of the crossing points 6. The hydrophobic coating 11 is also applied completely over the areas of the crossing points 6 in order to fully develop the water-repellent effect and effectively prevent discharge of the triboelectrical charge. Since advantageously, neither the weld connection between the warp threads 4 and the weft threads 5 nor the hydrophobic coating 11 protrudes into the mesh 7, there is practically no reduction in the mesh width 10. The permeability to light and air is thus maintained corresponding to the mesh width 10, regardless of the welding or the hydrophobic coating 11.

To manufacture the insect screen woven fabric 2 for use in an insect screen 1, according to the invention an ultrasonic welding process is used to produce the crossing points 6, followed by a coating process with the aid of a Foulard trough.

For this purpose, initially the woven fabric is bonded at the crossing points 6 by ultrasonic welding.

A dispersion of a fluoropolymer, in particular PTFE, is subsequently applied to the ultrasonically welded woven fabric. For this purpose, a Foulard trough, for example, is used, as is known for comparable purposes in the textile industry. The woven fabric now passes at a constant speed through a trough provided with the fluoropolymer solution, thus wetting the insect screen woven fabric 2 with liquid. The insect screen woven fabric 2 is subsequently guided between two rollers which squeeze the excess liquid from the woven fabric. The roller gap is variable so that the pressure with which the excess liquid is squeezed from the insect screen woven fabric 2 may be adjusted.

Next, the woven fabric 2 which, for example, is damp to the touch, is guided over a so-called tenter frame which holds the woven fabric at the edge region via needle fixing in such a way that that the preset woven fabric dimensions are precisely maintained. The residual moisture is now removed by condensation under the influence of heated air which is supplied to the insect screen woven fabric 2.

According to the invention, a cured, clear film composed of the fluoropolymer results which advantageously effectively prevents discharge of a triboelectrically generated charge.

To improve the adhesion of the hydrophobic coating 11, the threads may be roughened, in particular by treatment with a weak acid. The advantage of roughening the threads is improved adhesion of the coating. The application of a wetting agent to the woven fabric, which is likewise possible within the scope of the invention, results in a reduction of the surface tension of the hydrophobic coating 11 to be applied, thus advantageously counteracting interfering occlusion of the meshes.

Within the scope of the invention, it is likewise possible to apply the hydrophobic coating by ultrasonic welding prior to the bonding of the woven fabric.

The insect screen woven fabric 2 according to the invention may thus be produced using the method according to the invention.

The insect screen advantageously charges itself, in a manner of speaking, whereby discharge of the charge seldom occurs. As a result, according to the invention the insect screen woven fabric 2 may advantageously achieve a filtering effect with respect to pollen due to electrostatic effects, despite a mesh width 10 of the meshes 7 that is much greater than the typical size of pollen.

### LIST OF REFERENCE NUMERALS

1 Insect screen
2 Insect screen woven fabric
3 Frame
4 Warp thread
5 Weft thread
6 Crossing point
7 Mesh
8 Thread thickness
9 Thread thickness
10 Mesh width
11 Hydrophobic coating

What is claimed is:

1. A thread for producing a sheet material having a mesh structure, the thread comprising:
a carrier material that is triboelectrically chargeable by an air stream, the thread having a coating comprising a hydrophobic coating material.

2. The thread according to claim 1 wherein the carrier material includes a monofilament polymer material.

3. The thread according to claim 1 wherein the coating material includes a fluoropolymer.

4. The thread according to claim 1 wherein a thickness from an interval from 0.1 mm to 0.2 mm is selected.

5. A sheet material, such as a woven fabric, warp-knitted fabric, and/or weft-knitted fabric, for an insect screen, the sheet material comprising:
a plurality of threads arranged in a mesh structure, at least some of the threads within the plurality of threads comprising a carrier material that is triboelectrically chargeable by an air stream, the at least some of the thread having a coating comprising a hydrophobic coating material.

6. The sheet material according to claim 5, wherein a width of the mesh structure is at least 0.7 mm.

7. The sheet material according to claim 5, wherein the mesh structure includes warp threads and weft threads which are bonded to one another at crossing points by an adhesive, the adhesive including a polyester resin.

8. The sheet material according to claim 5 wherein the mesh structure includes warp threads and weft threads which are welded to one another at crossing points.

9. The sheet material according to claim 5 is a woven fabric within an insect screen.

10. A method for producing a sheet material, such as a woven fabric, the method comprising:
applying a coating comprising a hydrophobic coating material to a thread that is composed essentially of a carrier material which is triboelectrically chargeable by an air stream by moving the sheet material through a container filled with a medium containing the coating material.

11. The method according to claim 10 wherein the sheet material is drawn through a medium containing the coating material, preferably in dispersion, in particular diluted with water.

12. The method according to claim 10 further comprising the step of welding warp threads arranged in a mesh structure to weft threads at crossing points.

13. The method according to claim 10 further comprising the step of adhesively bonding warp threads arranged in a mesh structure to weft threads at crossing points.

14. The thread of claim 2 wherein the monofilament polymer material is a polyester.

15. The thread of claim 3 wherein the fluoropolymer is polytetrafluoroethylene.

16. The sheet material of claim 7 wherein the polyester resin is in an aqueous solution.

17. The method according to claim 12 wherein the warp threads arranged in a mesh structure are welded to weft threads at crossing points using ultrasound.
